(19) United States
(12) Patent Application Publication
(10) Pub. No.: US 2025/0363766 A1
(43) Pub. Date: Nov. 27, 2025

(54) Transform Upon Image Area of Interest

(71) Applicant: The Government of the United States, as represented by the Secretary of the Army, Washington, DC (US)

(72) Inventor: Robert DiIenno, Avondale, PA (US)

(21) Appl. No.: 18/671,239

(22) Filed: May 22, 2024

(51) Int. Cl. G06V 10/25; G06T 5/10; G06V 10/42; G06V 10/764

(52) U.S. Cl. CPC G06V 10/25; G06T 5/10; G06V 10/431; G06V 10/764; G06T 2207/20052

(57) ABSTRACT

Various embodiments relate to application of a two-dimensional discrete cosine transform upon an area of interest of a spatial image to create a frequency domain image. A sub-area of the frequency domain image can be identified and its inverse can be taken. The intensity of the inverse can be used to classify the sub-area. In one example, how the intensity changes over time can be used to classify the sub-area.

### GOVERNMENT INTEREST

The innovation described herein may be manufactured, used, imported, sold, and licensed by or for the Government of the United States of America without the payment of any royalty thereon or therefor.

### BACKGROUND

Cameras allow people to take pictures, such as smartphone cameras that capture images. The quality of these images can be dependent on a number of contextual factors, ranging from weather conditions to skill of the user. Additionally, the sophistication of camera hardware can influence the quality of the images. So while at times people can enjoy and use high quality photos, at other times people have to enjoy and use lesser quality photos.

### SUMMARY

In one embodiment, a system can be implemented, at least in part, by hardware, that comprises a transform component and an identification component. The transform component can be configured to apply a two-dimensional discrete cosine transform upon an area of interest of a spatial image to transform the area of interest of the spatial image into an area of interest of a frequency domain image. The identification component can be configured to identify a sub-area of interest from the area of interest of the frequency domain image through employment of a threshold.

In another embodiment, a method can comprise identifying a first intensity for a point spread function of a sub-area of an area of interest at a first time. The method can also comprises identifying a second intensity for the point spread function of the sub-area of the area of interest at a second time. Additionally, the method can comprise aggregating the first intensity and the second intensity into an intensity sequence. Further, the method can comprise causing the sub-area to be classified based, at least in part, on the intensity sequence.

In yet another embodiment, a non-transitory computer-readable medium, communicatively coupled to a processor, can store a command set executable by the processor to facilitate operation of a component set. The component set can comprise a first capture component configured to cause a capture of a first spatial image of a location at a first time by an imager and a second capture component configured to cause a capture of a second spatial image of the location at a second time subsequent to the first time by the imager. The component set can also comprise a first transform component configured to apply a two-dimensional discrete cosine transform upon an area of interest of the first spatial image to transform the area of interest of the first spatial image into an area of interest of a first frequency domain image and a second transform component configured to apply the two-dimensional discrete cosine transform upon an area of interest of the second spatial image to transform the area of interest of the second spatial image into an area of interest of a second frequency domain image. The area of interest of the first spatial image and the area of interest of the second spatial image can cover about the same portion of the location.

### BRIEF DESCRIPTION OF THE DRAWINGS

Incorporated herein are drawings that constitute a part of the specification and illustrate embodiments of the detailed description. The detailed description will now be described further with reference to the accompanying drawings as follows:

FIG. 1 illustrates one embodiment of an environment with a system comprising a transform component and an identification component;

FIG. 2A illustrates one embodiment of an environment with a system comprising the transform component, the identification component, an inversion component, an intensity component, a comparison component, and a classification component;

FIG. 2B illustrates one embodiment of an image set;

FIG. 2C illustrates one embodiment of a different environment for the system of FIG. 2A;

FIG. 3 illustrates one embodiment of a system comprising a processor and a computer-readable medium;

FIG. 4 illustrates one embodiment of a method comprising three actions;

FIG. 5 illustrates one embodiment of a method comprising seven actions;

FIG. 6 illustrates one embodiment of a method comprising six actions; and

FIG. 7 illustrates one embodiment of a process flow.

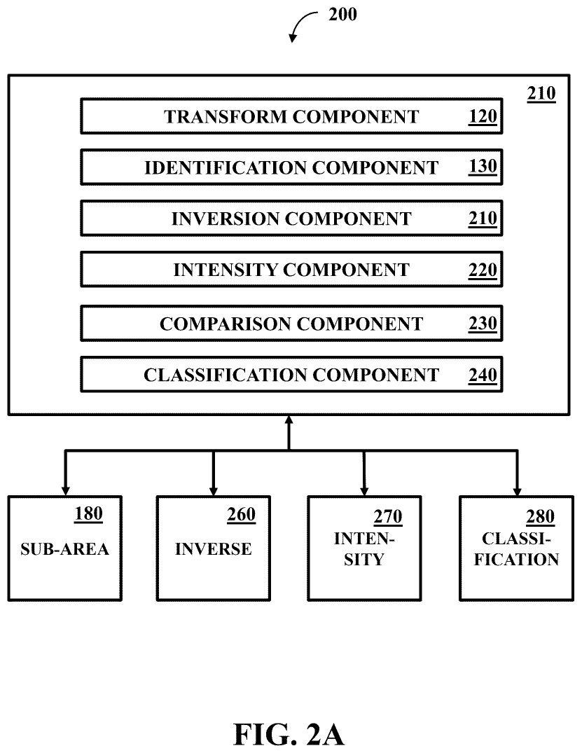

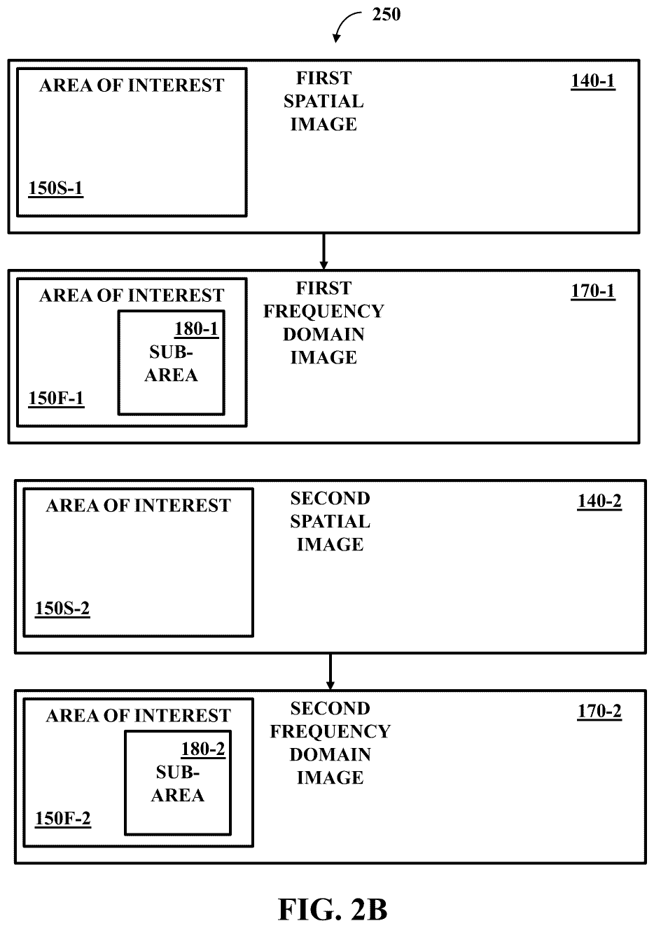

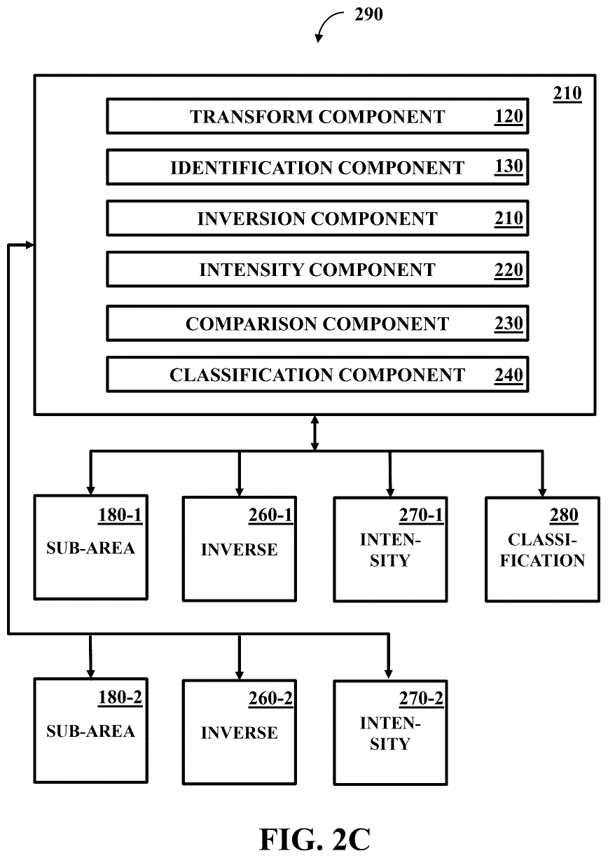

Multiple figures can be collectively referred to as a single figure. For example, FIG. 2 illustrates three subfigures—FIGS. 2A, 2B, and 2C. These can be collectively referred to as ‘FIG. 2.’

### DETAILED DESCRIPTION

While some images can be of a high quality, others can be of a lessor quality. When there are lessor quality images, aspects disclosed herein can be employed to process those images. This can be done by applying a two-dimensional discrete cosine transform upon an area of interest, taking an inverse of that result, and observing the intensity, such as the change in intensity over time. Based on this change, the area of interest can be classified.

The following includes definitions of selected terms employed herein. The definitions include various examples. The examples are not intended to be limiting.

“One embodiment”, “an embodiment”, “one example”, “an example”, and so on, indicate that the embodiment(s) or example(s) can include a particular feature, structure, characteristic, property, or element, but that not every embodiment or example necessarily includes that particular feature, structure, characteristic, property, or element. Furthermore, repeated use of the phrase “in one embodiment” may or may not refer to the same embodiment.

“Computer-readable medium”, as used herein, refers to a medium that stores signals, instructions and/or data. Examples of a computer-readable medium include, but are not limited to, non-volatile media and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, other optical medium, a Random Access Memory (RAM), a Read-Only Memory (ROM), a memory chip or card, a memory stick, and other media from which a computer, a processor or other electronic device can read. In one embodiment, the computer-readable medium is a non-transitory computer-readable medium.

“Component”, as used herein, includes but is not limited to hardware, firmware, software stored on a computer-readable medium or in execution on a machine, and/or combinations of each to perform a function(s) or an action(s), and/or to cause a function or action from another component, method, and/or system. Component may include a software controlled microprocessor, a discrete component, an analog circuit, a digital circuit, a programmed logic device, a memory device containing instructions, and so on. Where multiple components are described, it may be possible to incorporate the multiple components into one physical component or conversely, where a single component is described, it may be possible to distribute that single component between multiple components.

“Software”, as used herein, includes but is not limited to, one or more executable instructions stored on a computer-readable medium that cause a computer, processor, or other electronic device to perform functions, actions and/or behave in a desired manner. The instructions may be embodied in various forms including routines, algorithms, modules, methods, threads, and/or programs, including separate applications or code from dynamically linked libraries.

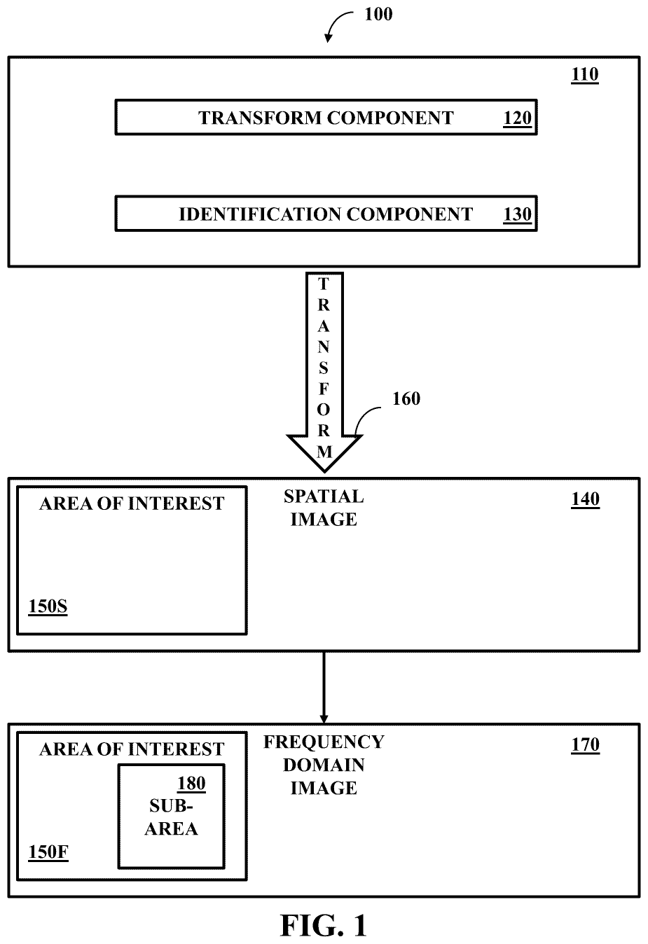

FIG. 1 illustrates one embodiment of an environment 100 with a system 110 comprising a transform component 120 and an identification component 130. In the environment 100, a camera can capture a spatial image 140. In an example that will be used throughout the detailed description, the image 140 can be captured by an amateur birdwatcher using her smartphone. With this example, the birdwatcher may try to capture an image of a bird and determine what bird they are viewing, hearing, and so on.

However, this image may be relatively poor. Reasons for this can very, such as the birdwatcher can try to zoom toward the bird to try to see the bird better, leading to poorer quality and possible distortion included due to user error such as difficulty keeping a steady hand during filming. Also, since the birdwatcher is an amateur, the camera capabilities of the smartphone may be limited in comparison to her professional counterpart, such as an ornithologist.

The birdwatcher can employ the system 110 to process at least part of the spatial image 140, such as the system 110 being an application resident upon a smartphone. In the image, the birdwatcher can identify an area they think they see a bird or an algorithm can make this identification of where a bird may be. This area can be considered an area of interest 150.

The transform component 120 can be configured to apply a two-dimensional discrete cosine transform 160 upon the area of interest 150 of the spatial image 140. This application can transform the area of interest 150 of the spatial image into an area of interest 150 of a frequency domain image 170. While the entire spatial image 140 can be transformed to the frequency domain image 170, in one embodiment just the area of interest 150 is transformed. In view of this, in FIG. 1 the area of interest 150 is designated as 150S in the spatial image 140 and 150F in the frequency domain image 150.

The identification component 130 can be configured to identify a sub-area 180 of interest (or sub-area of interest 180) from the area of interest 150F of the frequency domain image 170. This identification can be achieved thorough through employment of a threshold. The threshold can function as a filter for the area of interest 150F.

Consider the following example. The image spatial image 140 can be fifty pixels by thirty pixels. The birdwatcher can view the spatial image 140 and identify an area that might include a bird, this area being the area of interest 150S. The area of interest 150S can be defined by the birdwatcher and be relatively small, such as twenty-five pixels by twenty-five pixels, seven pixels by seven pixels, twenty pixels by fifteen pixels, or other sizes.

Due to a poor quality camera, it can be difficult to visually identify the bird in the spatial image. Therefore, the transform component 120 can apply the transform 160 upon the area of interest 150 to convert it from the spatial image 140 to the frequency domain image 170 and thus the area of interest 150S becomes the area of interest 150F.

With the area of interest 150F in the frequency domain image, the area of interest 150F can be the same size as the area of interest 150S, but individual pixels having a numerical value. The identification component 130 can compare these numerical values against a threshold value. If there is a match, then that pixel can be considered the sub-area of interest 180. The sub-area of interest 180 can be a single pixel. The sub-area of interest 180 can be subjected to further processing.

FIG. 2A illustrates one embodiment of an environment 200 with a system 210 comprising the transform component 120, the identification component 130, an inversion component 210, an intensity component 220, a comparison component 230, and a classification component 240. FIG. 2B illustrates one embodiment of an image set 250. FIG. 2C illustrates one embodiment of an environment 290 with the system 210. The system 200 can identify the sub-area of interest 180. Additionally, the system 200 can perform further processing on the sub-area of interest 180. An example of this further processing can be classifying the sub-area of interest 180.

The inversion component 210 can be configured to take an inverse 260 of the sub-area of interest 180. This inverse 260 can provide a point spread function and this inverse 260 removes background so the pixel of interest is isolated. With the pixel of interest being isolated, the pixel of interest can be classified.

To classify the pixel, the intensity component 220 can be configured to determine an intensity 270 of the sub-area of interest 180 through employment of the inverse 260. The comparison component 230 can be configured to compare the intensity 270 to a profile to produce a comparison result. The classification component 240 can be configured to make a classification 280 of the sub-area of interest 180 based, at least in part, on the comparison result.

The intensity 270 can be a numerical value. The system 210 can retain a database that provides classification options for the numerical value. The classification component 240 can compare the intensity 270 to options in the database. This can implement in different manners.

In one embodiment, the classification can be a binary classification being positive or negative in matching a desired feature. For example, the classification can be if the sub-area 180 includes a bird or not. The database can have a range. If the intensity fits within the range, then the classification component 240 classifies the sub-area 180 as positive (including a bird); if the intensity does not fit within the range, then the classification component 240 classifies the sub-area 180 as negative (not including a bird).

In another embodiment, the classification is not binary, but instead a more detailed classification. With this, the database can have multiple options: a first number range can be for a first bird (e.g., cardinal) and a second number range, non-overlapping with the first number range, can be for a second bird (e.g., blue jay). The classification component 270 can classify the sub-area 180, based on the intensity 270, as either cardinal, blue jay, or non-bird.

The above discussion can be based on the image being a photograph. However, more complex analysis can be performed. For example, the classification component 240 can operate based on a series of images (e.g., a video) and classify based on how the intensity changes over time. The can be performed by way of the system 210 in the environment 290 when processing the first spatial image 140-1 and second spatial image 140-2 of FIG. 2B.

The transform component 120 can be configured to apply the two-dimensional discrete cosine transform 160 of FIG. 1 upon the area of interest 150S-1 of the first spatial image 140-1 to transform the area of interest 150S-1 into an area of interest 150F-1 of a first frequency domain image 170-1. The transform component can be configured to apply the two-dimensional discrete cosine transform upon an area of interest 150S-2 of the second spatial image 140-2 to transform the area of interest 150S-2 into an area of interest 150F-2 of a second frequency domain image 170-2. The area of interest 150S-1 and the area of interest 150S-2 can cover about the same portion of a location (e.g., an area surrounding the same bird).

In one embodiment, a capture component can cause an imager (e.g., a stand-alone camera or smartphone) to capture of the first spatial image 140-1 and the second spatial image 140-2. These images 140-1 and 140-2 can be frames of a video sequential to one another. These images can be saved in the database and the transform applied to these saved images.

The inversion component 210 can be configure to take an inverse 260-1 (a first inverse) of a sub-area of interest 180-1 (a first sub-area of interest) of the first frequency domain image 170-1. The inversion component 210 can also be configured to take an inverse 260-2 (a second inverse) of a sub-area of interest 180-2 (a second sub-area of interest) of the second frequency domain image 170-2. The sub-area of interest 180-1 and the sub-area of interest 180-2 can cover about the same sub-portion of the location.

The intensity component 220 can be configured to determine an intensity 270-1, a first intensity, of the sub-area of interest 180-1 through employment of the inverse 260-1. The intensity component 220 can also be configured to determine an intensity 270-2, a second intensity, of the sub-area of interest 180-2 through employment of the inverse 260-2. The sub-areas of interest 180-1 and 180-2 can be of a small group of pixels or a single pixel.

Different comparisons can be employed to produce the classification 280. In one embodiment, the comparison component 230 can be configured to compare the intensity 270-1 to the intensity 270-2 to produce a comparison result. The classification component 240 can be configured to make the classification 280 based, at least in part, on the comparison result.

Returning to the bird example, the pixel intensity can change over time. This embodiment can observe how the intensity changes over time as the comparison. If this change is consistent with how a bird would change, based on a database entry, then the classification component 240 can produce the classification 280 of a bird.

In another embodiment, the comparison component 230 can configured to compare the intensity 270-1 to a profile to produce a first comparison result and to compare the intensity 270-2 to the profile to produce a second comparison result. The classification component 240 can be configured to make the classification 280 based, at least in part, on the first comparison result and the second comparison result.

This profile comparison and usage can be independent of or in conjunction with comparison the intensity 270-1 directly with intensity 270-2. The profile can include different expectancies for different times. For example, if the classification 280 is to be of a bird, then the intensity 270-1 can be expected to match a first part of the profile and the intensity 270-2 can be expected to match as second part of the profile. Similarly, how the intensities 270-1 and 270-2 compare to each other can be used to determine if the classification 280 should be of a bird or not.

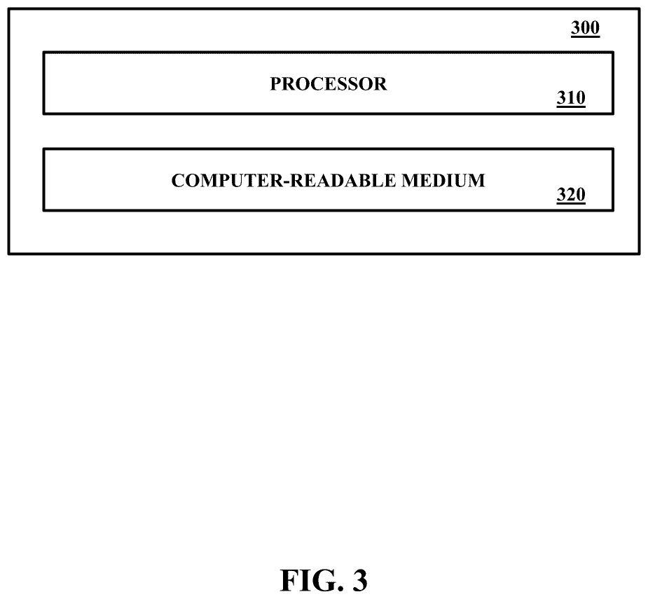

FIG. 3 illustrates one embodiment of a system 300 comprising a processor 310 and a computer-readable medium 320 (e.g., non-transitory computer-readable medium). In one embodiment, the computer-readable medium 320 is communicatively coupled to the processor 310 and stores a command set executable by the processor 310 to facilitate operation of at least one component disclosed herein (e.g., the transform component 120 of FIG. 1 implemented as a first transform component and a second transform component or a capture component). In one embodiment, at least one component disclosed herein (e.g., the classification component 130 of FIG. 1) can be implemented, at least in part, by way of non-software, such as implemented as hardware by way of the system 300. In one embodiment, the computer-readable medium 320 retains the database discussed above. In one embodiment, the computer-readable medium 320 is configured to store processor-executable instructions that when executed by the processor 310, cause the processor 310 to perform at least part of a method disclosed herein (e.g., at least part of one of the methods 400-600 discussed below) and implement operation related to the process flow 700 discussed below.

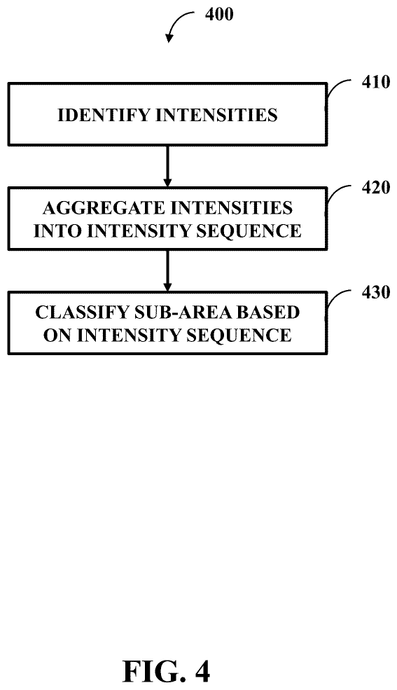

FIG. 4 illustrates one embodiment of a method 400 comprising three actions 410-430. At 410, there can be identifying the intensity 270-1 of FIG. 2 and at 420 there can be identifying the intensity 270-2 of FIG. 2. At 430, aggregating the intensity 270-1 and the second intensity 270-2 into an intensity sequence can occur. At 440, classifying the sub-area 180 of FIG. 2 can take place, with the sub-areas 180-1 and 180-2 defining about the same physical area. Action 440 can include causing this classification, such as causing the intensity sequence to be transferred downstream to a more powerful computing system to perform the actual classification. This classification can be performed by the classification component 240 of FIG. 2 and can be based, at least in part, on the intensity sequence with the intensity component 220 of FIG. 2 performing the actions 410-430.

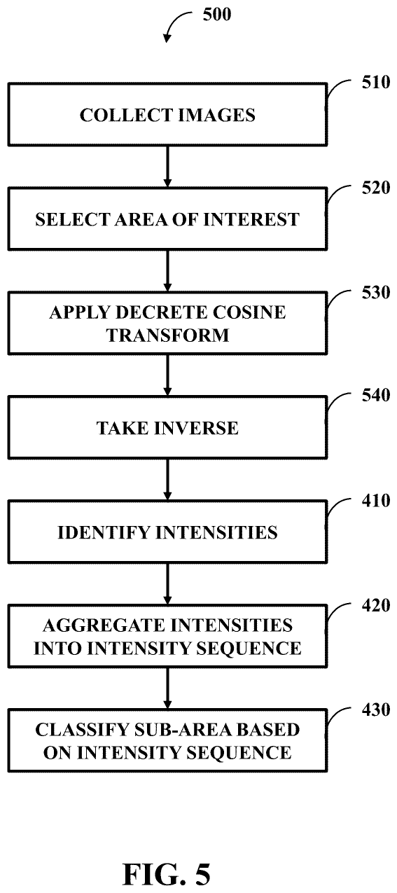

FIG. 5 illustrates one embodiment of a method 500 comprising seven actions 510-540 and 410-430. At 510, images can be collected, such as being captured or retrieved from a database (local or remote). These images can be collected as a video of an area of interest, with a first image being of a first time and a second image being of a second time subsequent to the first time.

At 520, an area of interest in the video can be selected (e.g., an area no bigger than twenty-five by twenty-five pixels). As opposed to identifying the area of interest chosen by a user, selection can occur though application of an artificial intelligence algorithm to identify an object that may be a bird. This selection can be for the area of interest at the first time and the second time.

At 530, a two-dimensional discrete cosine transform can be applied upon the area of interest at the first time to produce a frequency domain image at the first time. Also at 530, a two-dimensional discrete cosine transform can be applied upon the area of interest at the second time to produce a frequency domain image at the second time.

At 540, an inverse of a frequency domain image at a first time can be taken to produce a point spread function of a sub-area of the area of interest at the first time and an inverse of a frequency domain image at a second time can be taken to produce a point spread function of a sub-area of the area of interest at the second time. With the point spread functions produced, the intensities can be identified at 410, the intensity sequence can be produced at 420, and the sub-area can be classified at 430.

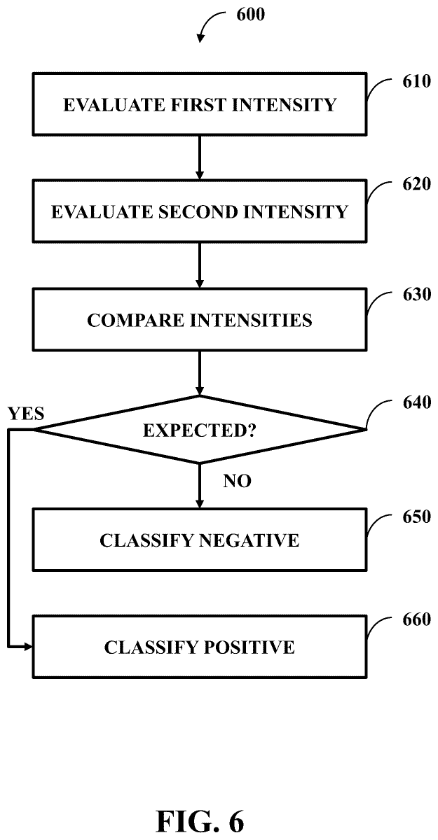

FIG. 6 illustrates one embodiment of a method 600 comprising six actions 610-660. At 610 and 620 the intensities can be evaluated. At 630, the intensities can be compared to one another. A check can occur at 640 to determine if the intensities are behaving as expected (e.g., how a bird is expected to have its intensities behave). If the intensities are not behaving as expected, then the classification can be negative at 650; if the intensities are behaving as expected, then the classification can be positive at 660.

While the methods disclosed herein are shown and described as a series of blocks, it is to be appreciated by one of ordinary skill in the art that the methods are not restricted by the order of the blocks, as some blocks can take place in different orders.

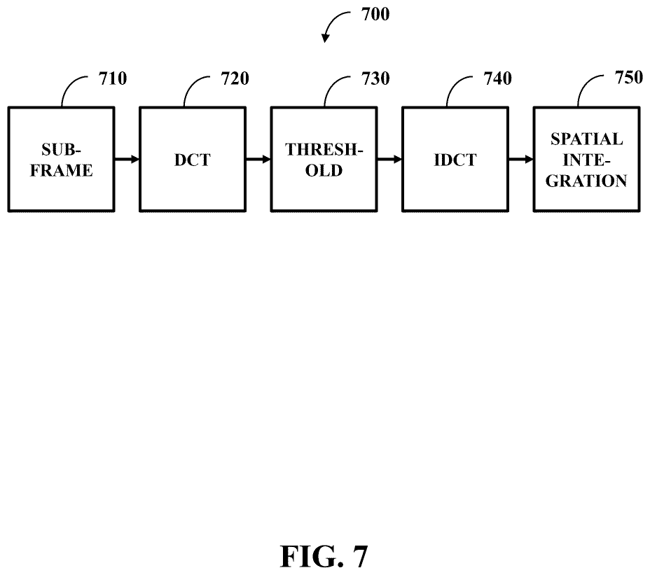

FIG. 7 illustrates one embodiment of a process flow 700. This flow 700 can be employed for sub-frame compression for recovery of unresolved point source intensity. It allows for separating background and foreground when considering an unresolved point source (e.g., the potential bird) as the foreground. This unresolved point source can be deemed as a region of interest (e.g., by a user or an artificial intelligence component). A sub-image can be identified that encapsulates the point source and a small amount of background data.

A noise reduction and image processing system can use a technique to remove unresolved point sources and treat them as noise. In a sensing system where the sensors do not have the resolution to resolve what the sensing system is looking for, the temporal information over time can become a source of information on the object that is of interest. Being able to separate that from the background while preserving the information can be beneficial. So aspects disclosed herein can be practiced with large field of view systems as sensors (e.g., the cameras discussed above) may not have the resolution to put enough pixels on even moderately large sized targets.

The sub-frame 710 (e.g., area of interest 150 of FIG. 1) can be a frame that is taken as part of a larger frame taken by a camera. In this technique, the sub-frame 710 can be up to a few pixels wider than the point spread function of the imager. The reason for sub-frame 710 is that a tailored threshold may not work on a full frame as the variation of a full frame is too vast to make an effective threshold.

The two-dimensional discrete cosine transform (DCT) 720 can be applied to the sub-frame 710. The threshold 730 can be a static threshold that is the theoretical DCT of the spread function on no background. In this, the threshold 730 can be employed as a filter to the sub-frame 710 after DCT 720 application to remove background. The inverse of the two-dimensional discrete cosine transform 740 can be taken. With the background removed and the inverse available, the remaining inverses can be integrated (added up) and the result can be the temporal value of the unresolved point source.

Commonly, when someone receives an image, what they are trying to look at spans multiple pixels, such as a bird of interest. However, in some cases there can be a single pixel that contains the bird of interest. Aspects disclosed herein can be practiced when there is only the single pixel available. The goal can be to preserve information from the unidentified point source (e.g., the potential bird), including the temporal information because over time the unidentified point source can change (e.g., the bird can flap its wings).

The energy from surrounding pixels can be removed. A bright pixel can be identified and surrounding that can be the area of interest 150S of FIG. 1 (e.g., nine by nine pixels or smaller) that can function as the sub-frame 710. The DCT 720 can be applied to the sub-frame 710. Using the nine by nine pixel example, this will result in eighty undesirable frequency pixels and desirable frequency pixel; the desirable frequency pixel is the sub-area 180 of FIG. 1. This desirable/undesirable can be discovered through use of the threshold 730 that functions as a mask (e.g., bird of interest is 100 Hertz (Hz), any pixel with 98-102 Hz will be accepted as the sub-area 180). Taking the inverse at 740 can leave a usable point spread function with higher energy (e.g., brightness) in comparison to the background; the inverse makes the sub-area 180 gives you the intensity of the point source that is of interest. With this, there can be accurate reproduction of temporal signatures at 750.

If an image has two items relatively similarly shaped next to each other, this can help identify them. As an example, a bird at rest and a leaf can have roughly the same profile size and shape. Over time, the leaf can move one way, such as sway in the wind, while the bird moves another, such as not swaying in the wind but having its chest expand and contract. A discriminator, such as a neural network, can classify the sub-area 180 of FIG. 1 and function as the classification component 240 of FIG. 2.

Observing this over time can help differentiate the leaf from the bird (e.g., remove the leaf so focus can be given to the bird). Observing the leaf and bird in the spatial domain can be problematic, such as at times them overlapping and being pushed together into a single pixel, so the frequency domain allows for the differentiation.

While aspects disclosed herein can be used in a variety of fields and applications, including those of long range viewing. While birdwatching was discussed in detail, aspects can be applied to other areas. Example areas can include astronomy, observation, and others. However, these can also be generally applicable to computer vision and image processing with the ability to extract temporal information of an unresolved point source that can be critically important to a sensing system (e.g., an apparatus that comprises the system 210 of FIG. 2). Also, while discussed as functioning with a single point source in an image, multiple point sources can be evaluated concurrently for a single image (e.g., two birds side by side can be evaluated individually, even if part of the same area of interest 150S of FIG. 1).

What is claimed is:

1. A system that is implemented, at least in part, by hardware, comprising:
a transform component configured to apply a two-dimensional discrete cosine transform upon an area of interest of a spatial image to transform the area of interest of the spatial image into an area of interest of a frequency domain image; and
an identification component configured to identify a sub-area of interest from the area of interest of the frequency domain image through employment of a threshold.

2. The system of claim 1, comprising:
an inversion component configured to take an inverse of the sub-area of interest from the area of interest of the frequency domain image.

3. The system of claim 2, comprising:
an intensity component configured to determine an intensity of the sub-area of interest through employment of the inverse of the sub-area of interest from the area of interest of the frequency domain image.

4. The system of claim 3,
were the spatial image is a first spatial image,
where the frequency domain image is a first frequency domain image,
where the inverse is a first inverse,
where the intensity is a first intensity,
where the transform component is configured to apply the two-dimensional discrete cosine transform upon an area of interest of a second spatial image to transform the area of interest of the second spatial image into an area of interest of a second frequency domain image;
where the identification component to identify a sub-area of interest from the area of interest of the second frequency domain image through employment of a threshold,
where the inversion component is configured to take an inverse of the sub-area of interest from the area of interest of the second frequency domain image.
where the intensity component is configured to determine a second intensity of the sub-area of interest through employment of the inverse of the sub-area of interest from the area of interest of the second frequency domain image,
where the first spatial image and the second spatial image capture about the same location,
where the area of interest of the first spatial image and the area of interest of the second spatial image cover about the same portion of the location, and
where the sub-area of interest from the area of interest of the first frequency domain image and the sub-area of interest from the area of interest of the second frequency domain image cover about the same sub-portion of the location.

5. The system of claim 4, comprising:
a comparison component configured to compare the first intensity to the second intensity to produce a comparison result; and
a classification component configured to make a classification of the sub-area of interest based, at least in part, on the comparison result.

6. The system of claim 4, comprising:
a comparison component configured to compare the first intensity to a profile to produce a first comparison result and to compare the second intensity to the profile to produce a second comparison result; and
a classification component configured to make a classification of the sub-area of interest based, at least in part, on the first comparison result and the second comparison result.

7. The system of claim 2, comprising:
a comparison component configured to compare the intensity to a profile to produce a comparison result; and
a classification component configured to make a classification of the sub-area of interest based, at least in part, on the comparison result.

8. The system of claim 1,
where the sub-area of interest is a single pixel.

9. A method, comprising:
identifying a first intensity for a point spread function of a sub-area of an area of interest at a first time;
identifying a second intensity for the point spread function of the sub-area of the area of interest at a second time;
aggregating the first intensity and the second intensity into an intensity sequence; and
causing the sub-area to be classified based, at least in part, on the intensity sequence.

10. The method of claim 9, comprising:
taking an inverse of a frequency domain image at a first time to produce the point spread function of the sub-area of the area of interest at the first time; and
taking an inverse of a frequency domain image at a second time to produce the point spread function of the sub-area of the area of interest at the second time.

11. The method of claim 10, comprising:
applying a two-dimensional discrete cosine transform upon the area of interest at the first time to produce the frequency domain image at the first time; and
applying a two-dimensional discrete cosine transform upon the area of interest the second time to produce the frequency domain image at the second time.

12. The method of claim 11, comprising:
collecting an image that includes the area of interest at the first time;
collecting an image that includes the area of interest at the second time subsequent to the first time;
selecting the area of interest from the image that includes the area of interest at the first time; and
selecting the area of interest from the image that includes the area of interest at the second time.

13. The method of claim 12,
where the area of interest is no larger than twenty-five pixels by twenty-five pixels.

14. The method of claim 13,
where the sub-area is a single pixel.

15. The method of claim 14,
where classifying the sub-area is a binary classification being positive or negative in matching a desired feature.

16. A non-transitory computer-readable medium, communicatively coupled to a processor, that stores a command set executable by the processor to facilitate operation of a component set, the component set comprising:
a first capture component configured to cause a capture of a first spatial image of a location at a first time by an imager;
a second capture component configured to cause a capture of a second spatial image of the location at a second time subsequent to the first time by the imager;
a first transform component configured to apply a two-dimensional discrete cosine transform upon an area of interest of the first spatial image to transform the area of interest of the first spatial image into an area of interest of a first frequency domain image; and
a second transform component configured to apply the two-dimensional discrete cosine transform upon an area of interest of the second spatial image to transform the area of interest of the second spatial image into an area of interest of a second frequency domain image,
where the area of interest of the first spatial image and the area of interest of the second spatial image cover about the same portion of the location.

17. The non-transitory computer-readable medium of claim 16, the component set comprising:
a first inversion component configured to take an inverse of a sub-area of interest from the area of interest of the first frequency domain image;
a second inversion component configured to take an inverse of a sub-area of interest from the area of interest of the second frequency domain image;
a first intensity component configured to determine a first intensity through employment of the inverse of the sub-area of interest from the area of interest of the first frequency domain image; and
a second intensity component configured to determine a second intensity through employment of the inverse of the sub-area of interest from the area of interest of the second frequency domain image,
where the sub-area of interest from the area of interest of the first frequency domain image and the sub-area of interest from the area of interest of the second frequency domain image cover about the same sub-portion of the location.

18. The non-transitory computer-readable medium of claim 17,
where the sub-area of interest is a single pixel.

19. The non-transitory computer-readable medium of claim 18, the component set comprising:
a comparison component configured to compare the first intensity to the second intensity to produce a comparison result; and
a classification component configured to make a classification of the sub-area of interest based, at least in part, on the comparison result.

20. The non-transitory computer-readable medium of claim 18, the component set comprising:
a comparison component configured to compare the first intensity to a profile to produce a first comparison result and to compare the second intensity to the profile to produce a second comparison result; and
a classification component configured to make a classification of the sub-area of interest based, at least in part, on the first comparison result and the second comparison result.
